(19) United States
(12) Patent Application Publication
(10) Pub. No.: US 2019/0297395 A1
(43) Pub. Date: Sep. 26, 2019

(54) AUTOMATED METER READING

(71) Applicant: Yunteng Huang, Palo Alto, CA (US)

(72) Inventor: Yunteng Huang, Palo Alto, CA (US)

(21) Appl. No.: 15/934,997

(22) Filed: Mar. 24, 2018

(51) Int. Cl. H04Q 9/00; G01D 4/00; H04N 7/18

(52) U.S. Cl. CPC H04Q 9/00; H04Q 2209/40; H04N 7/18; G01D 4/002

(57) ABSTRACT

A meter reader unit includes an image sensor that captures images of a face of a meter to produce image data. A computer vision processor recognizes meter data within the images. The meter data includes numerical values that indicate unit usages as measured by the meter. A wireless transceiver transmits the meter data to a remote entity. A power source provides power to the meter reader unit. A volume of the meter data transmitted to the remote entity is less than a volume of the image data so that power required to transmit the meter data is less than would be required to transmit the image data.

### BACKGROUND

A smart meter is an electronic device that records consumption of electricity, water or gas in intervals of days, hours, minutes or less, and communicates that information to utilities or users for monitoring and possibly control. Utility usage is reported and charged accordingly to each household by respective utility providers. Smart electricity meters using power line communication (PLC) have been deployed in many regions. Other systems using dedicated cabling also exist. The benefit of wired system is reliability and power sufficient. The disadvantage is cost and difficulty to install. A wireless system, on the other hand, has the benefit of easy installation; however, achieving a wireless meter system that has a two to ten years of battery life of meter operation is often a challenge for meter and communication design.

Since the installed metering infrastructure is massive, the conversion of traditional metering system to smart metering system has proven to be very slow and costly.

### BRIEF DESCRIPTION OF THE DRAWINGS

FIG. 1 of a wireless utility meter reading system in accordance with an embodiment.

FIG. 2 shows an adapter for a meter reader unit in accordance with an implementation.

FIG. 3 shows a meter reader unit connected to a water meter in accordance with an implementation.

FIG. 4 shows a meter reader unit connected to an electricity meter in accordance with an implementation.

FIG. 5 shows a meter reader unit connected to a gas meter in accordance with an implementation.

FIG. 6 shows a simplified block diagram of a meter reader unit in accordance with an implementation.

FIG. 7 illustrates signal flow within a meter reader unit in accordance with an implementation.

FIG. 8 shows examples of meter image and readout values utilizing computer vision in accordance with an implementation.

### DESCRIPTION OF THE EMBODIMENTS

An automatic meter reading (AMR) device is retrofit to traditional analog meters to modern smart meters. An AMR device is also sometimes referred to as an Advanced Metering Infrastructure (AMI). In this disclosure, AMR device and AMI are considered interchangeable terms. A meter used in an AMR device or an AMI system is often referred as a smart meter.

For example, a retrofit AMR device joins a utility provider's network, or is a customer device not joined to a utility provider's network. The AMR device allows traditional utility meters, such as electricity, water and gas meters, to be converted to smart meters that allow frequent utility usage monitoring. Image sensors and computer vision is used to extract the meter reading, as described further below. The meter reading is transmitted to a remote server continuously or in a batch. The wireless meter reading system includes one or a plurality of meters having an attached adaptor device to read and transmit the meter reading data wirelessly to customer site or to a remote server. The attached reading device includes an image sensor such as in a digital camera, a computer vision unit to convert images to meter reading data and a wireless transmit and receive unit.

For example, a wireless utility meter reading system is at least one meter, one adaptor device, a network or internet gateway and a host computer. The meter can be electricity, water or gas meter. The meter can be a modern smart meter where usage is displayed digitally or can be legacy analog meters where rotary dials represent the reading and revolving disk representing the instantaneous rate of usage. The adaptor device consists of an image sensor, a computer vision processor to convert the images to meter reading data, a wireless transceiver and a power source such as a battery. The internet gateway can be a router that connects to the Internet and connects to the meter reader wirelessly. The host computer can be a local computer, or a server in the cloud such as Amazon Web Services (AWS) or Google Cloud.

For example, an image sensor takes images of the meter at a user configurable speed, such as one image every second or one image every minute or 10 minutes. The reading accuracy of the accumulated utility usage is not dependent on the frame rate of the image sensor. The reading accuracy of the instantaneous usage is dependent on the frame rate of the image sensor. The tradeoff for high frame rate is battery life of the adaptor device.

A more frequent gathering of meter reading data not only can alert users and utility companies of abnormal usage pattern, but also can help users to see where and how utilities are used so users can modify usage, upgrade appliance, detect leaks. This ultimately results in energy and water conservation, household safety and environmental sustainability.

A first objective is to provide a utility meter reading system which allows homeowners to monitor the rate of real time usage as well as accumulated usage of electricity, water and gas.

A second objective is to provide a utility meter reading system where an adaptor can be attached to any existing utility meter, and where the installation of such an adaptor does not require electricity, water or gas professionals.

A third objective is to provide a utility meter reading system that can work with modern smart meters or legacy analog meters.

A fourth objective is to provide a utility meter reading system where an adaptor can read the meter on its own and transmit the meter reading data instead of image data, hence low power low data rate wireless radio, such as LoRa, NBIoT radios, can be used to extend battery life of the adaptor.

A fifth objective is to provide a utility meter reading system where the installation does not require interruption to the utility service.

A sixth objective is to provide a utility meter reading system where detailed usage data can be analyzed and reported such as individual appliance usage, abnormal usage pattern, leak detection etc.

A seventh objective is to provide a utility meter reading system where utility usage data, analysis and conservation suggestions can be shown on a smart phone or displayed on a household appliance.

An eighth objective is to provide a utility meter reading system that does not interfere or obstruct meter reading of utility companies.

The present disclosure describes an apparatus and methods that can convert all traditional meters into smart meters at reasonable cost and can be installed by home owners without the need of licensed professionals.

The benefit of having computer vision processing within the adaptor unit is to dramatically reduce the amount of data that need to be transmitted to the server. For example, each typical reading of meter equipped with computer vision processing contains approximately a few hundred bytes of data where an image of the meter is typically a few hundred thousand bytes. Low data rate for the wireless link allows long range and low power radios, such as LoRa or NB-IoT, to be used to transmit the meter reading data to remote servers. This obviates the need to transmit large image data to servers.

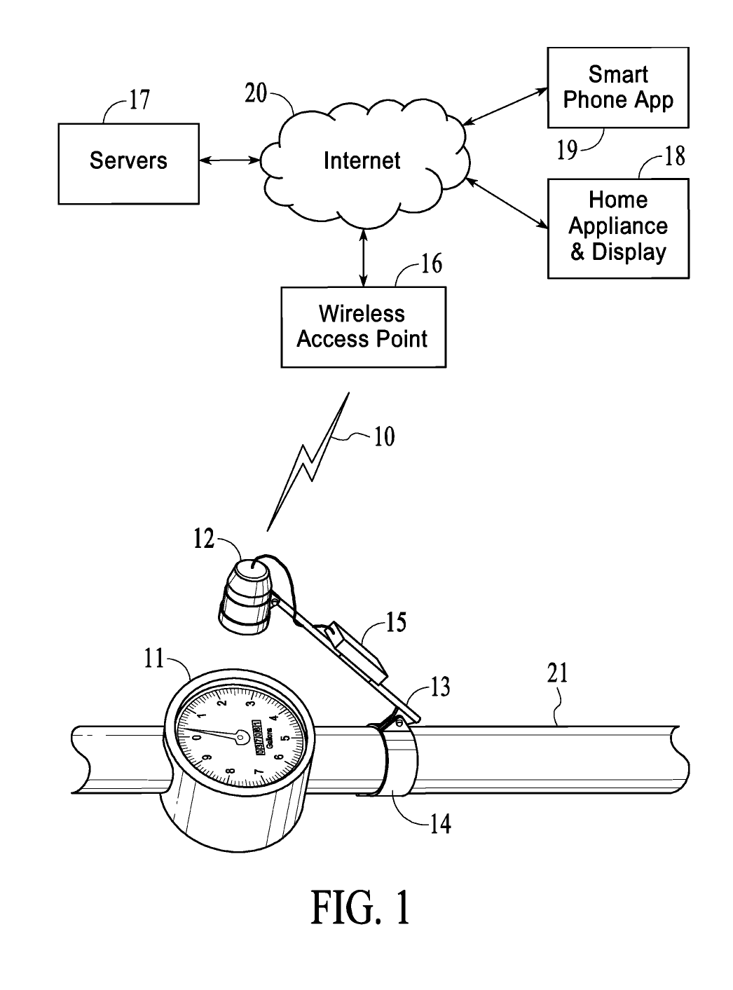

An exemplary embodiment of a wireless meter reading system is shown in FIG. 1. The system includes one or more meters, as represented by a meter 11. For example, meter 11 is shown as a water meter but can be another type of utility meter such as an electricity meter or a gas meter. Meter 11 can also be another type of meter such as a pressure meter, a humidity meter, a temperature meter or another type of meter. For example, meter 11 can be a digital or an analog electricity meter, a digital or an analog water meter, a digital or an analog gas meter, digital or an analog pressure meter, a digital or an analog thermometer, a digital or analog humidity meter.

For example, meter 11 can be a passive meter without any electric power needed. Alternatively, meter 11 can be a meter with electricity supplied by battery, by environmentally scavenged power source or by electricity wire connection. The meters display relevant data with multiple clock hands with dials, or with digital readouts like odometers, or with LCD display. Some meters also have rotating indicators for small amount of flow which is usually for detecting water or gas leaks. Some modern meters have digital LCD display where the display can be turned off most of the time to save battery consumption. The display can be turned on either by pushing a button or by interrogating the meter electronically.

A meter reader unit 12 captures images of the face of meter 11 using an image sensor, for example, as used within digital cameras. Meter reading unit 12 interprets the captured images to produce meter reading numbers. For example, optical character recognition is used when meter 11 unit displays information digitally. When meter 11 uses dials or other means to display information, meter reading unit 12 interprets current dial position to detect current meter reading values. To perform this interpretation, meter reading unit 12 includes processing power implemented by hardware and software sufficient to perform the processing. Meter reading unit 12 produces interpreted meter data 10 that is transmitted wirelessly to a wireless access point by a wireless transceiver within meter reading unit 12. Meter data 10 can be transmitted as it is generated, or meter data 10 can be collected within meter reading unit 12 and transmitted in a batch at a less frequent rate.

A holding arm 13 is used to position meter reading unit 12 so that the image sensor will be able to capture images of the face of meter 11. A mounting bracket 14 can be used to attach the holding arm 13 to a nearby fixture. For example, in FIG. 1, mounting bracket 14 is implemented as a clip that attaches holding arm 13 to a pipe 21.

A power source 15 is separate from, or incorporated within, meter reading unit 12. For example, power source 15 is a battery, an electric outlet, or an environmentally scavenged power source such as a solar panel, a radio wave, a wind turbine or so on.

A wireless transceiver within meter reading unit 12 communicates with another wireless transceiver illustrated in FIG. 1 by a wireless access point 16. Wireless access point 16 can be implemented by a wireless hub or other configuration. Depending on the wireless technology used within meter reading unit 12, wireless access point 16 can be established using Wi-Fi, ZigBee, Z-Wave, LoRa, or NB-IoT or another wireless protocol. Wireless access point 16 can connect to the Internet 20 directly as shown in FIG. 1 or can connect to the Internet 20 via a router and so on.

A server 17 processes and stores data from meter reading unit 12. For example, server 17 performs data analytics using the current and historic data to detect abnormal usage patterns and come up with utility saving recommendations. For example, real time and historic usage data can also be displayed in home on appliances such as smart refrigerators, or other home display devices such as Echo Show, or Google Display. This is represented in FIG. 1 by home appliance and display 18. Alternatively, or in addition, data stored on or produced by server 17 can be accessed by a user computing device, as illustrated in FIG. 1 by a smart phone app 19 which can be run on a smartphone, or another application that runs on another type of computing device such as a tablet or laptop computer.

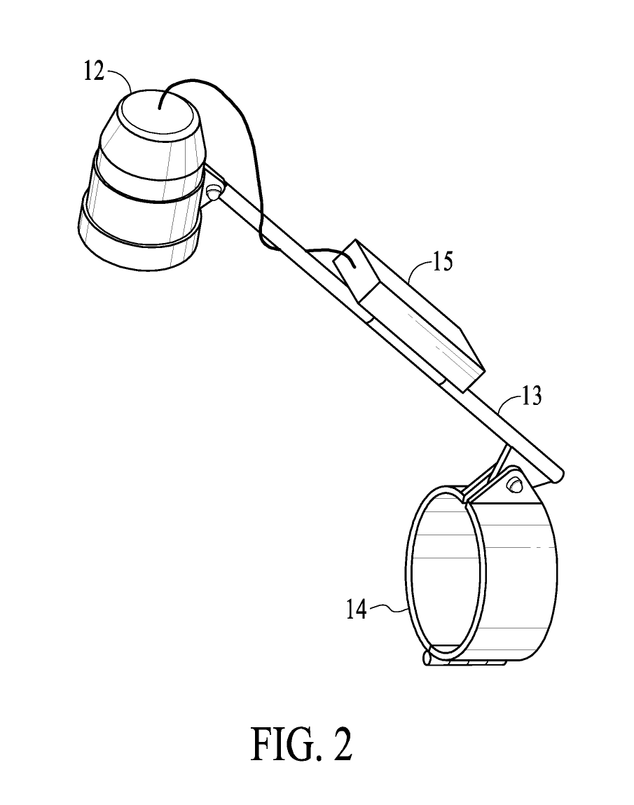

FIG. 2 shows additional detail of holding arm 13, power source 15, meter reading unit 12 and mounting bracket 14. For example, holding 14 is adjustable to allow adaption to various meter configurations.

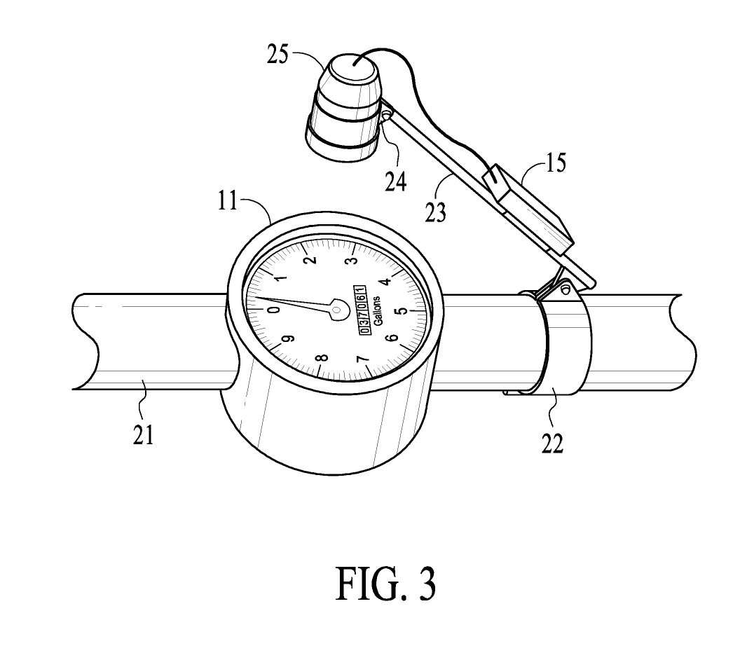

FIG. 3 shows an implementation where a holding arm 23 is used to position a meter reading unit 25 so that an image sensor within meter reading unit 25 is able to capture images of the face of water meter 11. A mounting device 24 attaches holding arm 23 to meter reading unit 25. A mounting bracket 22 is used to attach holding arm 23 to pipe 21. A power source, such as power source 15, can be used to power meter reading unit 25.

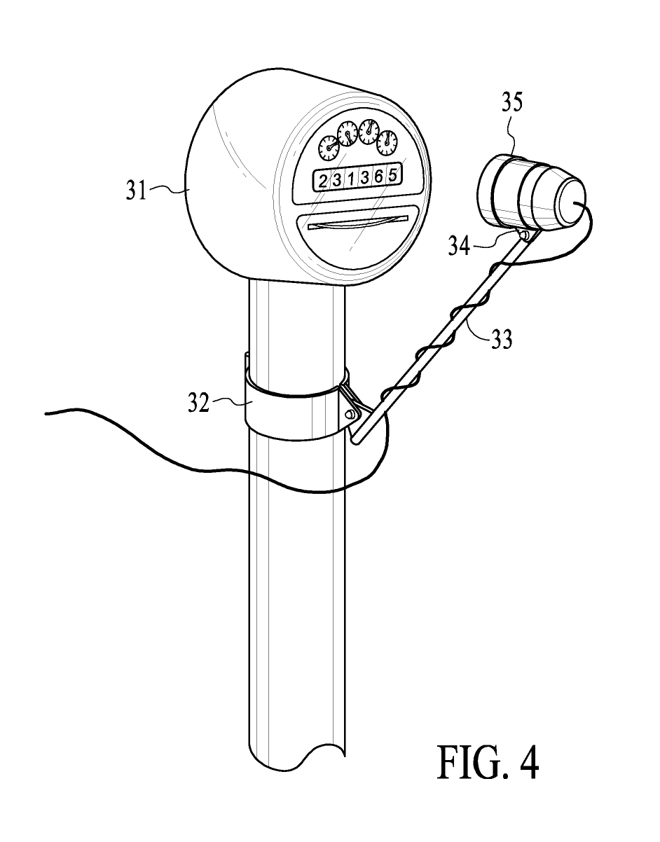

FIG. 4 shows an implementation where a holding arm 33 is used to position a meter reading unit 35 so that an image sensor within meter reading unit 35 is able to capture images of the face of an electricity meter 31. A mounting device 34 attaches holding arm 33 to meter reading unit 35. A mounting bracket 32 is used to attach holding arm 33 to electricity meter 31.

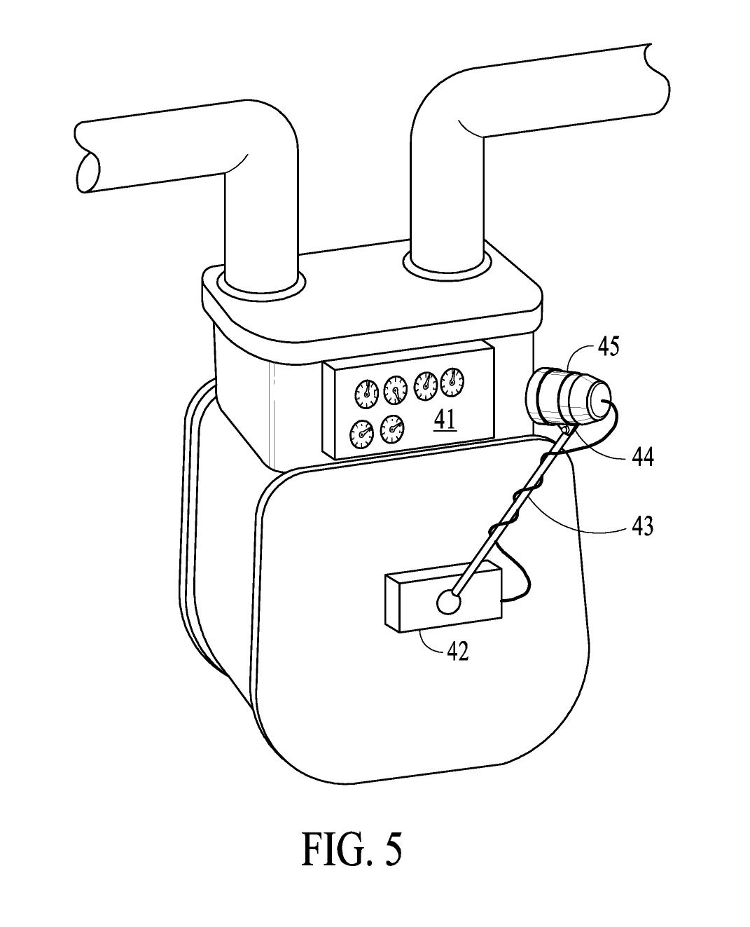

FIG. 5 shows an implementation where a holding arm 43 is used to position a meter reading unit 45 so that an image sensor within meter reading unit 45 is able to capture images of the face of a gas meter 41. A mounting device 44 attaches holding arm 43 to meter reading unit 45. A mounting bracket 42 is used to attach holding arm 43 to gas meter 41.

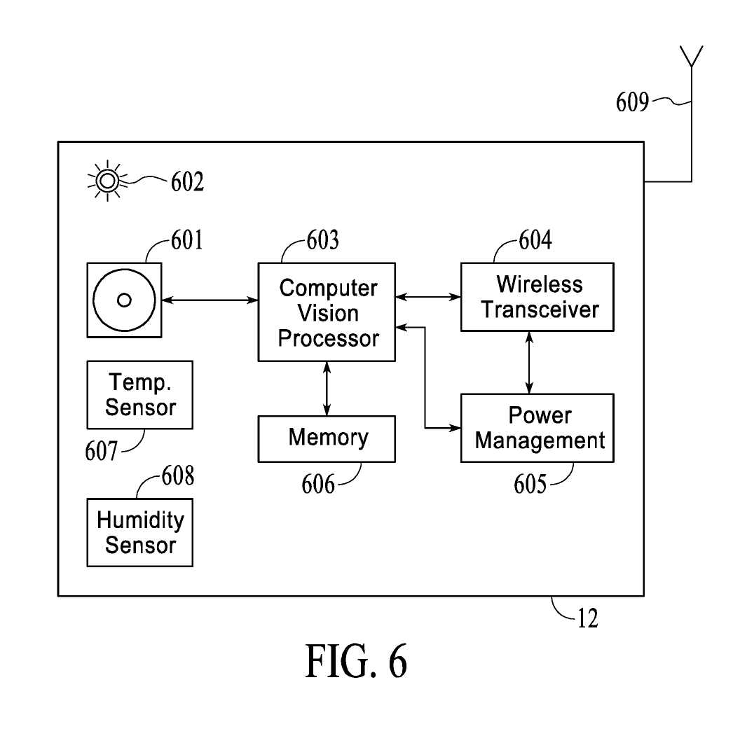

FIG. 6 is a simplified block diagram of meter reading unit 12. An image sensor 601 and an illuminating light emitting diode (LED) 602 are used to capture images of a meter. Optics are additionally used as helpful with image sensing. Image sensor 601 captures an image of the meter and the resulting image data is sent to a computer vision processor 603. For example, the image data may or may not be compressed into a format such as JPEG. The image data is processed by computer vision processor 603 to extract meter data from the image data. For example, the meter data consists of numerical values that numerically represent a current meter reading. For example, the meter data can include a meter identification, a meter model number in addition to current displayed values. The meter value data may represent units such as gallons or cubit feet for a water meter, kilowatts for an electricity meter, therms for a gas meter and so on.

An optional external memory unit 606 may be used if called for by a particular processor implementation. Meter data is transferred to a wireless transceiver 604, which sends the meter data to a nearby access point via radio wave with the aid of an antenna 609.

For example, computer vision processor 603 is implemented by an application specific integrated circuit (ASIC), a field programmable gate array (FPGA), a graphics processing unit (GPU) or another type of generic or specialized processor that has the required computing power and memory. For example, a computer vision algorithm running on computer vision processor 603 uses a neural network model for extracting meter data. For example, the algorithm allows recognition to be trained and developed using public available meter image data, meter manufacturer data, commercial collected meter images and user contributed images. For example, the computer vision algorithm and model are updated via wireless computing with meter reading unit 12. Optical character recognition software or other types of recognition software may be utilized or adapted to extract meter data, as is well understood by persons of ordinary skill in the art.

Additional features may also be incorporated within meter reading unit 12. For example, FIG. 6 shows a temperature sensor 607 and a humidity sensor 608. Other environmental sensors may also be included in meter reading unit 12. For example, temperature and humidity data are collected by computer vision processor 603 and sent to the access point along with meter data. For example, all transmitted data can be encrypted or otherwise encoded.

To increase battery life, power management 605 is included. For example, meter reading unit 12 is programmed to take readings at a predetermined time interval, or on demand as a result of an instruction send via the wireless access point to meter reader unit 12. For example, to achieve maximum battery life, meter reader unit 12 is configured to turn on once an hour, or once a day or once over a longer period of time.

For example, a portion or all of meter reading unit 12 can be implemented using individual integrated circuits or utilizing a system-on-a-chip (SoC) integration. For example, a single SoC is used to implement computer vision processor 603, memory 606 wireless transceiver 604, power management 605, temperature sensor 607, humidity sensor 608, image sensor 601 and LED 602.

For example, in various implementations a radio within meter reading unit 12 can be used to establish communication with the meter when the meter is a smart meter. Wireless signaling to a smart meter can also be used by the meter reading unit 12 to instruct the smart meter to turn on a display of the smart meter before meter reading unit 12 captures an image of the face of the meter.

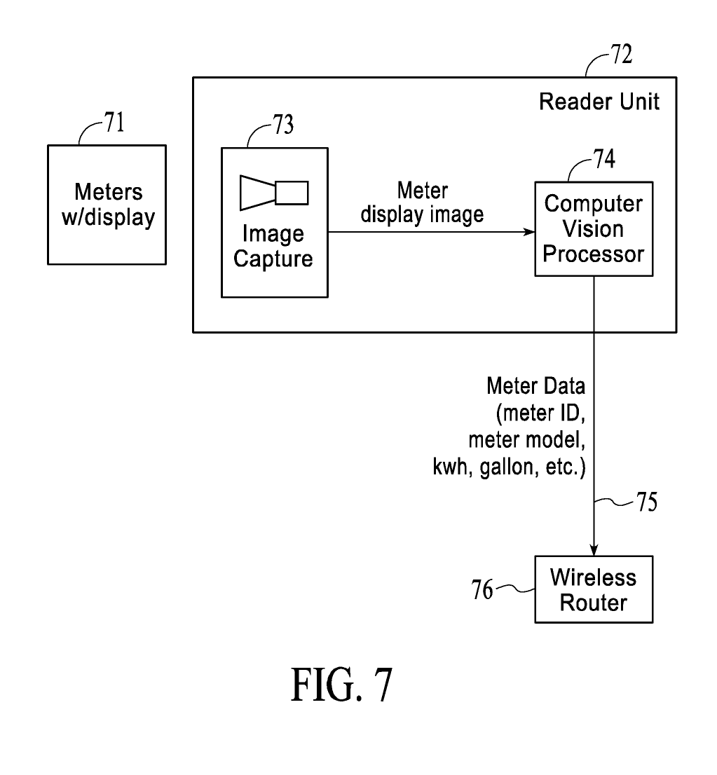

FIG. 7 illustrates signal flow within a meter reader unit 72 in accordance with an implementation. A current state of a meter display 71 is captured to produce image capture data 73. A computer vision processor 74 produces meter data 75 for transfer to a wireless access point such as a wireless router 76. Meter data can include, but is not limited to: meter ID, utility company name, meter model in addition to values such as kilowatts, cubit feet, therms, depending upon the type of meter being viewed.

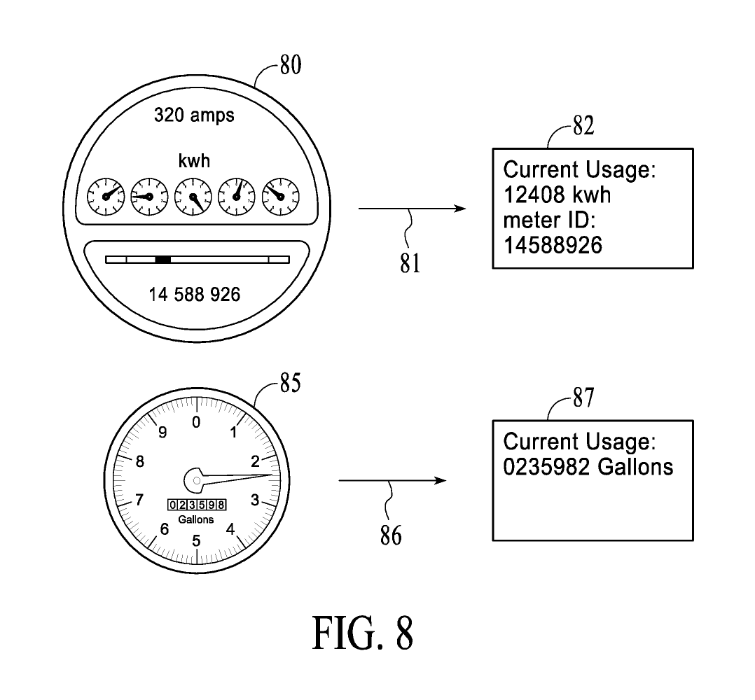

FIG. 8 shows examples of meter image and readout values utilizing computer vision. For example, image data 81 is captured from a meter 80. A computer vision processor translates image data 81 into a numerical value for kilowatt usage. The resulting meter data 82 includes the numerical value 12408 representing an electricity usage in kilowatts and a meter ID number 14588926.

For example, image data 86 is captured from a meter 85. A computer vision processor translates image data 86 into a numerical value for gallon usage. The resulting meter data 87 includes the numerical value 0235982 representing a water usage in gallons.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope, which is set forth in the following claims.

What is claimed is:

1. A meter reader unit comprising:
an image sensor that captures images of a face of a meter to produce image data;
a computer vision processor that recognizes meter data within the images, the meter data including numerical values that indicate unit usages as measured by the meter; and
a wireless transceiver that transmits the meter data to a remote entity;
wherein a power source provides power to the meter reader unit; and
wherein a volume of the meter data transmitted to the remote entity is less than a volume of the image data so that power required to transmit the meter data is less than would be required to transmit the image data.

2. A meter reader unit as in claim 1 wherein the meter is a utility meter that measures, electricity usage, water usage or gas usage.

3. A meter reader unit as in claim 1 wherein the meter is one of a plurality of meters read by the meter reader unit.

4. A meter reader unit as in claim 1, wherein the remote entity is a wireless access point.

5. A meter reader unit as in claim 1, wherein the meter data additionally includes a meter model identification and a meter serial number.

6. A meter reader unit as in claim 1, wherein the power source is a battery or an environmentally scavenged power source.

7. A meter reader unit as in claim 1, additionally comprising:
optics and an illuminating light source that aid with image sensing.

8. A meter reader unit as in claim 1, additionally including power management circuitry.

9. A meter reader unit as in claim 1, additionally comprising:
a temperature sensor; and
a humidity sensor.

10. A meter reader unit as in claim 1, additionally comprising:
a radio establishes communication with the meter; wherein the meter is a smart meter.

11. A meter reader unit as in claim 1, wherein the meter reader turns on a display of the meter via wireless signaling before capturing an image of the face of the meter.

12. A meter reader unit as in claim 1, wherein the meter is one of the following:
A digital or analog electricity meter;
a digital or analog water meter;
a digital or analog gas meter;
a digital or analog pressure meter;
a digital or analog thermometer;
a digital or analog humidity meter.

13. A meter reader system comprising:
a meter reading unit, including
an image sensor that captures images of a face of a meter to produce image data,
a computer vision processor that recognizes meter data within the images, the meter data including numerical values that indicate unit usages as measured by the meter, and
a wireless transceiver that transmits the meter data to a remote entity, wherein a volume of the meter data transmitted to the remote entity is less than a volume of the image data so that power required to transmit the meter data is less than would be required to transmit the image data;
a power source that provides power to the meter reader unit; and,
a meter reading adapter that holds the meter reading unit in a position that allows the image sensor to capture the images of the face of the meter.

14. A meter reader system as in claim 13 wherein the meter is one of a plurality of meters read by the meter reader unit.

15. A meter reader system as in claim 13, wherein the meter data additionally includes a meter model identification and a meter serial number.

16. A meter reader system as in claim 13, wherein the meter is one of the following:
A digital or analog electricity meter;
a digital or analog water meter;
a digital or analog gas meter;
a digital or analog pressure meter;
a digital or analog thermometer;
a digital or analog humidity meter.

17. A method of reading a meter, comprising:
using an image sensor within a meter reading unit to capture images of a face of a meter to produce image data;
using a computer vision processor within the meter reading unit to recognize meter data within the images, the meter data including numerical values that indicate unit usages as measured by the meter; and
using a wireless transceiver within the meter reading unit to transmit the meter data to a remote entity, wherein a volume of the meter data transmitted to the remote entity is less than a volume of the image data so that power required to transmit the meter data is less than would be required to transmit the image data.

18. A method as in claim 17 wherein the meter is one of a plurality of meters read by the meter reader unit.

19. A method as in claim 17 additionally comprising:
turning on a display of the meter via wireless signaling before capturing an image of the face of the meter.

20. A method as in claim 17, wherein the meter is one of the following:
A digital or analog electricity meter;
a digital or analog water meter;
a digital or analog gas meter;
a digital or analog pressure meter;
a digital or analog thermometer;
a digital or analog humidity meter.
